(19) United States
(12) Patent Application Publication
(10) Pub. No.: US 2023/0376743 A1
(43) Pub. Date: Nov. 23, 2023

(54) TRACE REPRESENTATION LEARNING

(71) Applicant: Oracle International Corporation, Redwood Shores, CA (US)

(72) Inventors: Marija Nikolic, Zurich (CH); Nikola Milojkovic, Dietikon (CH); Arno Schneuwly, Effretikon (CH); Matteo Casserini, Zurich (CH); Milos Vasic, Zurich (CH); Renata Khasanova, Zurich (CH); Felix Schmidt, Baden-Dattwil (CH)

(21) Appl. No.: 17/748,226

(22) Filed: May 19, 2022

(51) Int. Cl. G06N 3/08; G06N 20/00

(52) U.S. Cl. CPC G06N 3/08; G06N 3/088; G06N 20/00

(57) ABSTRACT

The present invention avoids overfitting in deep neural network (DNN) training by using multitask learning (MTL) and self-supervised learning (SSL) techniques when training a multi-branch DNN to encode a sequence. In an embodiment, a computer first trains the DNN to perform a first task. The DNN contains: a first encoder in a first branch, a second encoder in a second branch, and an interpreter layer that combines data from the first branch and the second branch. The DNN second trains to perform a second task. After the first and second trainings, production encoding and inferencing occur. The first encoder encodes a sparse feature vector into a dense feature vector from which an inference is inferred. In an embodiment, a sequence of log messages is encoded into an encoded trace. An anomaly detector infers whether the sequence is anomalous. In an embodiment, the log messages are database commands.

### FIELD OF THE INVENTION

The present invention relates to avoiding overfitting in deep neural network (DNN) training. Herein are multitask learning (MTL) and self-supervised learning (SSL) techniques for training a multi-branch DNN to encode a sequence.

### BACKGROUND

Anomaly detection has attracted considerable attention in industry due to its importance in defending computer systems from harmful activities, whether malicious or accidental. Databases are prone to various kinds of attacks. Machine learning (ML) algorithms that analyze system logs play an important role in detecting such activities. Database logs represent structured sequences of data composed of messages, where each message is composed of attributes that describe the message.

Referred to herein as traces, message subsequences are of particular importance for an anomaly detection task. Existing methods that convert trace information into numerical vectors typically extract hand-crafted features directly from the messages, and subsequently aggregate the features across messages into a trace representation. The aggregation is done by rigidly calculating statistics such as mean, mode, sum, minimum, and maximum per feature. The main limitations of these methods are (i) the requirement for manually defined aggregation strategies, (ii) equal weighting of messages that carry different information, (iii) feature space dimensionality and sparsity, (iv) no semantics captured, and (v) loss of the message ordering. To address these limitations, a data-driven approach is required.

### BRIEF DESCRIPTION OF THE DRAWINGS

In the drawings:

FIG. 1A is a block diagram that depicts an example computer that avoids overfitting in deep neural network (DNN) training based on multitask learning (MTL) and self-supervised learning (SSL) techniques for training a multi-branch DNN to encode a sequence;

FIG. 1B is a block diagram that depicts an example computer that reuses an already-trained encoder in a production application;

FIG. 2 is a flow diagram that depicts a first example computer process to avoid over-fitting by MTL and SSL techniques for training a multi-branch DNN to encode a sequence;

FIG. 3 is a flow diagram that depicts a second example computer process to avoid overfitting by MTL and SSL techniques for training a multi-branch DNN to encode a sequence;

FIG. 4 is a flow diagram that depicts an example computer process for future proof training of an encoder;

FIG. 5 is a block diagram that illustrates a computer system upon which an embodiment of the invention may be implemented;

FIG. 6 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

For anomaly detection in computer system activity, representation of sequences of related log messages may play a crucial role. The goal is to condense a message sequence into a feature vector whose content and format facilitates task-specific machine learning (ML). Herein is an ML approach that automatically discovers the best representations of such sequences. The approach is completely data-driven, eliminates the need for manual feature engineering, and improves scalability and performance. As an alternative to heuristic feature engineering, learned representations are useful for various tasks such as anomaly detection, clustering, similarity detection, predictive analysis, and search.

Deep learning (DL) is an example of a data-driven approach for capturing data structure and learning useful feature representations from input data. Techniques herein can extract and reuse neural layers of a DL model that provide data representations. The motivation comes from the fact that the neural network needs to learn useful features of the data, including data representations, to solve a given task. Representations obtained this way are contextualized to capture semantics and can facilitate different downstream tasks such as classification, regression, or clustering that perform better with better representations of inputs.

DL for extracting useful data representations is applied herein to logs and log-based anomaly detection. None of the existing approaches is ideally suited to this case because of their supervised learning nature. Supervised learning requires a massive amount of labeled data. The problem addressed herein is when no labels are provided, which requires a different approach.

Self-supervised learning (SSL) herein drives representation learning. Producing data with reliable labels is expensive and requires significant human effort. Self-supervised learning herein is a way to train ML models to learn tasks without humans providing labeled data. In this approach, labels are based on the data itself and are automatically synthesized according to a specified self-supervised learning task.

For example if the application domain were computer vision, images could be randomly rotated and then automatically labeled according to the performed rotation to help train an ML model to detect how much rotation or whether rotation exceeds a threshold. That is a contrived task whose purpose is to help the ML model learn high-quality and reusable features from given data. Various self-supervised tasks may be designed to provide a supervisory signal for training. Once trained, the ML model reliably extracts learned representations that are reusable for other (e.g. new) ML tasks. Learned representations carry semantic and structural information that is beneficial for the downstream tasks. The quality of resulting representations may be directly related to the quality and/or variety of contrived self-supervised tasks.

SSL has success with natural language processing (NLP). However, there are substantial differences between log analytics and NLP. Unlike words, which are associated with limited-size vocabularies, the space of possible log messages can be extremely large. Some experimentation demonstrated a mismatch between tasks for database logs and related anomaly detection versus tasks of other application domains. Herein is a self-supervised approach with innovative tailoring for representation learning of log traces. The approach includes novel self-supervised tasks and custom model architectures.

Herein are multiple unique self-supervised tasks for representation learning. The tasks are carefully designed to suit the nature of the data and may or may not be inspired by the downstream task of a real application, namely log-based anomaly detection. Introduction of multiple tasks for model training is motivated by improved generalization that can result from more or less pooling together labels coming from different tasks. The model architecture can be adjusted in novel ways to suit the nature of the designed tasks.

This approach of self-supervised representation learning of structured data sequences, which contain arbitrary attributes and can be partitioned, has not been proposed in the literature. Applying this approach to database logs provides trace representations that increase the accuracy and reliability of anomaly detection applications. Increased accuracy means fewer false positives (i.e. false alarms), which conserves computer resources such as time and space for other purposes such as executing the underlying application and/or more intensive automation that reacts to true positives.

Example contrived tasks for self-supervised representation learning of log traces include: (i) detecting a given trace is corrupted (corruption task) and (ii) detecting a sub-sequence does not belong to a given sequence (fake sub-trace detection task). The goal of the tasks is to encourage an ML model during training to scrutinize the validity of provided input sequences, thus capturing a temporal data structure that is reusable for an anomaly detection task such as in a production environment.

For both contrived training tasks, positive and negative examples are obtained or synthesized to provide necessary supervisory signal to train the model. For the corruption task, negative examples (non-corrupted) are original traces themselves. The positive examples are obtained by corrupting messages of original traces such as by replacing a certain percentage of trace messages with randomly selected messages from another trace.

In an embodiment, a reconfigurable model architecture is based on a multi-branch sequential neural network. The model is composed of two input branches, each containing a bidirectional long short-term memory (BiLSTM) network layer that has memory components that facilitate capturing dependencies and preserving ordering information. BiLSTM is an extension of conventional long short-term memory (LSTM) networks for improving model performance on sequence related problems.

The following are advantages of techniques herein.
Dimensionality reduction: experiments achieved satisfactory anomaly detection performance by reducing the feature space by around 60% compared to the dimensionality of feature vectors produced using non-learned representations.
Reduced feature vector complexity: approaches based on non-learned representations require manual selection of aggregation(s) (e.g., mean, mode, minimum, etc.) per feature, with a bias toward conservative overengineering with too many statistical aggregation features to avoid losing information without knowing the relative importance of the many features and their aggregation statistics.
Improved generalization and robustness: multitask learning (MTL) offers advantages such as reduced overfitting through shared representations, improved data and learning efficiency, and improved prediction accuracy. The learned representations can be used in any kind of database behavior analysis.
Improved scalability/reusability: SSL automatically learns representations that expresses common characteristics of different applications, which entails transfer learning.

In an embodiment, a computer first trains a neural network to perform a first task. The neural network contains: a first encoder in a first branch, a second encoder in a second branch, and an interpreter layer that combines data from the first branch and the second branch. The neural network second trains to perform a second task. After the first and second trainings, production encoding and inferencing occur. The first encoder encodes a sparse feature vector into a dense feature vector from which an inference is inferred.

In an embodiment, a computer self-supervised first trains an encoder to encode a sequence of log messages into an encoded trace. The computer connects, after the first training, the encoder to a neural network. The neural network second trains to detect whether a sequence of log messages is anomalous. In various embodiments, the second training is or is not self-supervised.

In an embodiment, a computer generates a neural network that accepts a complete sequence of log messages and a subsequence of log messages as input. The neural network contains an encoder that can encode the complete sequence of log messages into an encoded trace. The neural network self-supervised trains to detect whether the complete sequence of log messages contains the subsequence of log messages. The encoder is trained by training the neural network, after which, the encoder is deployed without the neural network.

### 1.0 Example Computer

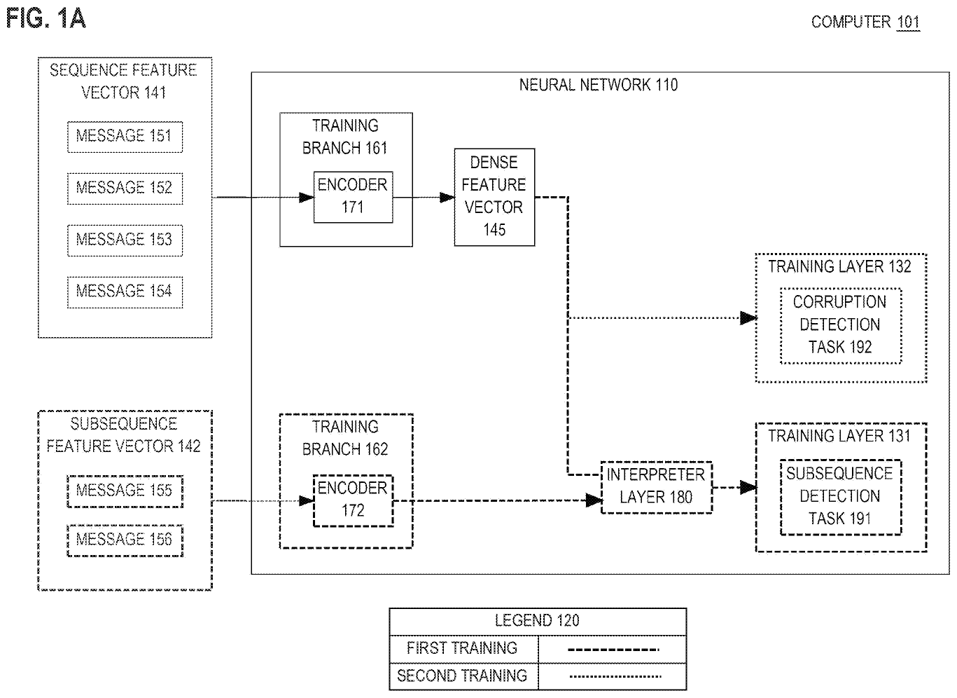

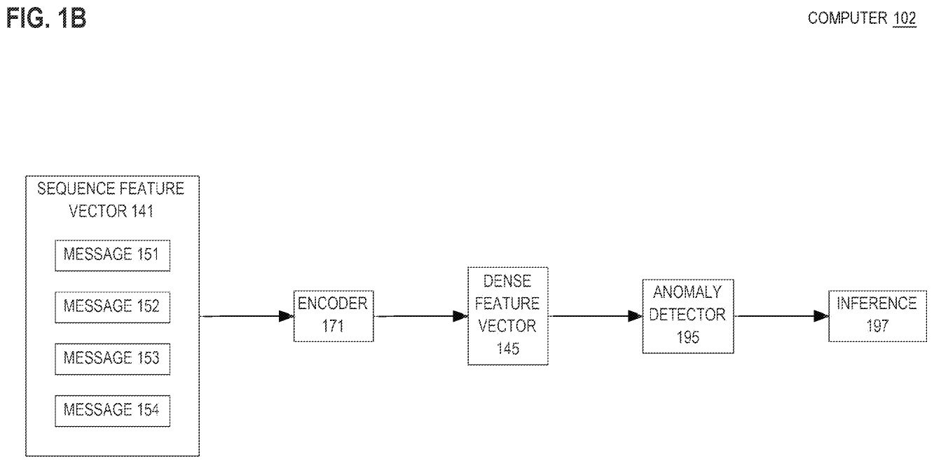

FIG. 1A is a block diagram that depicts an example computer 101, in an embodiment. Computer 101 avoids overfitting in deep neural network (DNN) training based on multitask learning (MTL) and self-supervised learning (SSL) techniques for training a multi-branch DNN to encode a sequence. Computer 101 may be one or more of a rack server such as a blade, a personal computer, a mainframe, a virtual computer, a smartphone, or other computing device.

Neural network 110 is an artificial neural network (ANN), such as a DNN, that is hosted in the memory of computer 101 and operated by computer 101. Unlike other ANNs that are trained only once and have a same internal architecture across the lifecycle of the ANN, neural network 110 is differently trained multiple times. Each time neural network 110 is trained, the internal architecture of neural network 110 changes.

### 1.1 Multitask Learning (MTL)

In this example, neural network 110 experiences first and second trainings as shown in demonstrative legend 120 that is not a component of computer 101. Legend 120 shows a distinct line style for each of both trainings. Components of computer 101 that are present only during one respective training are drawn with the line style shown in legend 120 for that training. Components of computer 101 that are instead drawn with a solid line are present for both trainings.

Each of both trainings has a distinct task for neural network 110 to learn. As shown, the first and second trainings entail respective tasks 191-192 that neural network 110 will not perform as part of a production application. Herein a production task is: a) part of a production application and b) a task that neural network 110 does not train to perform.

The training tasks prevent overfitting that encoder 171 (discussed later herein) would incur if multiple training tasks were unused. First and second trainings should occur in sequence, but the ordering of training tasks does not matter. For example, the second training may occur before the first training.

Training for multiple tasks is referred to herein as multitask learning (MTL). MTL herein may differ from other kinds of MTL as follows.
MTL herein distinguishes training tasks from a production task. Other kinds of MTL may lack training tasks and instead have production tasks.
Tasks 191-192 herein are trained separately and in sequence. Other kinds of MTL may simultaneously train for all tasks in a single training.
The internal architecture of neural network 110 may differ for different tasks. Other kinds of MTL may instead leave the internal architecture unchanged across the lifecycle of neural network 110.
The input format (e.g. feature vector count and/or width) herein may differ for different tasks. Other kinds of MTL may instead leave the input format unchanged across the lifecycle of neural network 110.

### 1.2 Feature Engineering

In this example, the first training entails subsequence detection task 191 during which neural network 110 contains internal components 131, 161-162, 171-172, and 180 but not training layer 132. The first training simultaneously accepts two sparse feature vectors 141-142 as input. Each of feature vectors 141-142 is a sparse encoding of a sequence of messages such as some of messages 151-156.

Each of messages 151-156 may be a structured or semi-structured aggregation of data fields of same or different datatypes. Each of messages 151-156 may be a record such as a database table row, a network packet or multi-packet protocol data unit (PDU), a document such as JavaScript object notation (JSON) or extensible markup language (XML), a command such as a shell command or a database statement, or a log entry such as a line of text in a console output logfile.

In an embodiment, a feature vector such as feature vectors 141-142 contains a sparse encoding of a sequence of messages as a sequence (e.g. array) of separate sparse encodings of individual messages in the sequence. Each message is encoded with a same format that contains a respective value for each of many features (e.g. data fields) in the message. The feature vector is a concatenation of all of the feature values for all of the messages in the sequence.

All messages have respective values for the same features. For example if there are ten features and sequence feature vector 141 consists of an array of all feature values of messages 151-154, then the respective values of the first feature for messages 151-152 may be encoded into the first and eleventh elements of the array.

Each feature has a respective datatype. For example, two features may have a same or different respective datatype. A datatype may variously be: a) a number that is an integer or real, b) a primitive type such as a Boolean or text character that can be readily encoded as a number, c) a sequence of discrete values such as text literals that have a semantic ordering such as months that can be readily encoded into respective numbers that preserve the original ordering, or d) a category that enumerates distinct categorical values that are semantically unordered.

One categorical feature may be hash encoded into one number in a feature vector or n-hot or 1-hot encoded into multiple numbers. For example, 1-hot encoding generates a one for a categorical value that actually occurs in a feature vector and also generates a zero for each possible categorical value that did not occur in the feature vector. Encoding one feature as multiple numbers is an example of sparse encoding.

Features may be respective data fields, attributes, or columns that can occur in each of messages 151-156. In an embodiment, a feature vector is homogenous and respective values of all features are encoded as a same datatype such as a same primitive datatype such as an integer or a unit normalized real number such as floating point. In an embodiment, a feature vector instead is heterogenous, and each feature may have its own respective encoding datatype.

In an embodiment, a sequential feature such as a calendar month may be encoded as a zero or one based unsigned integer such as 1-12 instead of as text strings such as January. In an embodiment, categorical features such as a feature of unordered and mutually exclusive choices such as tea flavors may be so-called one-hot encoded as a group of mutually exclusive Boolean features. For example, one choice from three flavors may be encoded into three Boolean features in which the corresponding feature is true and the two other Boolean features are false in the feature vector. In an embodiment, a Boolean feature is encoded as a number.

### 1.3 Domain Specific Features

In an embodiment, sparse feature vectors 141-142 are sparse encodings of one or more database statements. For example, some features may respectively be: a timestamp of a database statement, an identifier of a database session, a network address of a database client, an identifier of an operating system (OS) of a database client, and at least a portion of a database statement. The following are example features that may or may not occur in messages 151-156 that each represent a respective database statement that is live or stored in a log of a database server.
A whole or part of an open database connectivity (ODBC) or Java ODBC (JDBC) uniform resource locator (URL) that was used to establish a network connection and a database session. Example connection string parts include standard URL parts (e.g. protocol, server host, and network port number) and ODBC/JDBC specific parts in the path or query parameters such as a name of a database, schema, or user account.
An indication of how old was the database session when the database session issued the database statement.
A 1-hot encoding of the dialect of structured query processing language (SQL) of the database statement such as data definition language (DDL), data manipulation language (DML), data query language (DQL), and transaction control language (TCL).
A 1-hot encoding of the verb of the database statement such as SELECT, INSERT, DELETE, UPDATE, CREATE, DROP, GRANT, BEGIN, and COMMIT.
An n-hot encoding of the state or context of the database statement such as: outside of a transaction, inside a demarked transaction, auto-committed transaction, and prepared statement.
A return code of the database statement such as an error code.
A count of rows in the result set returned by the database statement.
An n-hot encoding of database tables referenced by a database statement.
A detail of a WHERE clause such as a count of joins specified, a LIMIT clause on results, a sorting direction, and the DISTINCT keyword.

Subsequence detection task 191 detects whether or not the sequence of messages encoded in sequence feature vector 141 contains the subsequence of messages encoded in subsequence feature vector 142. For example messages 155-156 may or may not be identical to respective messages 152-153 or respective messages 153-154. For performing subsequence detection task 191, neural network 110 may be somewhat inefficient or somewhat inaccurate.

However, efficiency and accuracy of training tasks 191-192 are not the primary purpose of the first and second trainings. The primary purpose of training tasks 191-192 is to use MTL to train encoder 171 to transcode sparsely encoded sequence feature vector 141 into dense feature vector 145 that is a dense encoding without overfitting encoder 171. Overfitting would cause encoder 171 to be reliable for familiar instances of sequence feature vector 141 and unreliable for unfamiliar instances of sequence feature vector 141.

Preventing overfitting future proofs encoder 171 to handle message sequences that did not exist and were not contemplated when neural network 110 was trained. Future proofing tolerates data drift and/or concept drift, such as when production data gradually diverges from training data. Future proofing facilitates less frequent retraining of encoder 171 with more recent data such as for data drift. Less frequent retraining conserves resources of computer 101 such as time and space.

The first and second trainings use self-supervised learning (SSL). With SSL, computer 101 automatically derives a labeled training corpus from an unlabeled training corpus. In the first training, messages may be ordered into sequences of three general sizes (i.e. counts of messages) that are respectively referred to herein as original, uniform, and subsequence.

The unlabeled corpus contains the original sequences, which are longest sequences and may vary in message count due to application semantics (e.g. database sessions) and due to logistics (e.g. logfile rotation). In various embodiments, a logfile contains interleaved sequences of messages of respective clients or sessions, and computer 101 does or does not untangle the logfile into fully separated multiple original sequences, where each original sequence contains messages from only one session or client. In an embodiment, a whole logfile is used as one monolithic original sequence, no matter how many sessions or clients contributed messages to the logfile.

Computer 101 divides each original sequence into multiple uniform sequences that contain a fixed count of messages that is how many messages are encoded into an instance of sequence feature vector 141. In various embodiments, message 152 can or cannot occur in multiple uniform sequences. For example, a window may have a same message count as sequence feature vector 141, and the window may incrementally slide over an original sequence to generate multiple uniform sequences.

As the window slides, older message(s) slide out of the window and newer message(s) slide into the window. Whichever messages are simultaneously in the window are used together as a uniform sequence. If the increment (i.e. stride) of sliding is fewer messages than the window contains, then a same message may be in multiple partially overlapping uniform sequences. Otherwise, uniform sequences are contiguous but do not overlap, and a message can be in only one uniform sequence.

For SSL, some or all of the uniform sequences are encoded into respective instances of sequence feature vector 141. For each instance of sequence feature vector 141 used in the first training, a corresponding instance of subsequence feature vector 142 is generated so that both instances can be concurrently accepted by respective branches 161-162. Some of the instances of subsequence feature vector 142 actually encode subsequences of the corresponding uniform sequence, and those instances are labeled as genuine. Other instances of subsequence feature vector 142 instead encode subsequences of an unrelated (i.e. not corresponding) uniform sequence or encode a randomly generated or randomly tampered subsequence, and those instances are labeled as fake.

Subsequence detection task 191 learns to infer the label of a pair of feature vectors 141-142. SSL provides the correct labels needed for supervised training of neural network 110 based on whether or not training layer 131 infers a correct or incorrect label. When the first training begins, neural network 110 is more or less inaccurate. When the first training ends, neural network 110 is more or less accurate.

### 1.4 Encoder

Encoder 171 provides dimensionality reduction, which: a) entails avoiding analysis and integration of irrelevant features of a message sequence, and b) generates a more concise (i.e. dense) representation of the message sequence in which only meaningful input features are retained. In other words, encoder 171 extracts semantic details of a complex, noisy, and fuzzy input. Thus, encoder 171 converts sparse feature vector 141 that is a sparse representation of a message sequence into dense feature vector 145 that is a dense encoding.

Generally during the first and second trainings, encoder 171 learns which features should be deemphasized and how to encode retained semantic features. In an embodiment, encoder 171 is an autoencoder. An architecture for an autoencoder is discussed later herein. In an embodiment, encoder 171 is a recurrent neural network (RNN) for analyzing a sequence. In an embodiment, encoder 171 is composed of bidirectional long short-term memory (BiLSTM) neurons to prevent the vanishing gradient problem in backpropagation.

### 1.5 Multi-Branch Neural Network

During the first training, neural network 110 is multi-branch. Herein, a multi-branch neural network contains multiple input branches such as training branches 161-162 that concurrently operate during the first training. Neurons and neural layers in one branch are not directly connected to other branches, and branches cannot communicate with each other.

Each branch concurrently accepts a separate respective feature vector. Although feature vectors 141-142 of branches 161-162 may have different respective widths and formats, in an embodiment the encoding format of all messages 151-156 is the same in both feature vectors 141-142. For example if messages 151 and 156 are identical, then their encodings are identical in feature vectors 141-142.

Encoder 172 in training branch 162 may be somewhat similar to encoder 171 in branch 161. Encoders 171-172 transcode sparse feature vectors 141-142 that contain message sequences of different respective lengths into dense encodings of different respective widths. During the first training, both dense encodings by encoders 171-172 are concurrently accepted by interpreter layer 180.

Interpreter layer 180 learns to integrate both dense encodings into a combined representation that training layer 131 accepts and that preserves message sequence semantics that training layer 131 needs to perform subsequence detection task 191. Herein, each of layers 131-132 and 180 and branches 161-162 may contain a respective sequence of one or more neural layers.

Neurons of each neural layer in a shown layer or branch is (e.g. fully) connected to neurons of a respective next neural layer in the shown layer or branch. Likewise, neurons of a last neural layer in a shown layer or branch (e.g. branch 161) is (e.g. fully) connected to neurons of a first neural layer in a respective next shown layer (e.g. interpreter layer 180).

Reinforcement learning in neural network 110 may be based on backpropagation as discussed later herein. For example, backpropagation may be conveyed in a backwards sequence that entails, in the following ordering, training layer 131, interpreter layer 180, and concurrently branches 161-162. Thus, the first training trains all of internal components 131, 161-162, 171-172, and 180.

### 1.6 Changing Between Training Tasks

The second training entails corruption detection task 192. During the second training, neural network 110 contains internal components 132, 161, and 171 but not internal components 131, 162, 172, and 180. The second training uses instances of sequence feature vector 141 but not subsequence feature vector 142. During the second training, neural network 110 is not multi-branch in this example.

In the first training, neural network 110 learned accurate connection weights, which are coefficients as discussed later herein. The connection weights are preserved for the second training that refines the connection weights. Thus, encoder 171 undergoes refinement during the second training to prevent overfitting.

In various embodiments, the second training does or does not reuse some or all of the uniform sequences or instances of sequence feature vector 141. Some instances of sequence feature vector 141 encode real uniform sequences and are labeled as genuine. Other instances of sequence feature vector 141 encode randomly generated or randomly tampered sequences and are labeled as fake. In the second training and based on SSL, training layer 132 learns to infer the label of an instance of sequence feature vector 141 in a supervised fashion that is somewhat similar to the first training.

The following are example negative aspects (i.e. exclusions) of various example embodiments of neural network 110.
Neural network 110 does not comprise a convolutional neural network (CNN) nor a recurrent neural network (RNN) nor a natural language processing (NLP) transformer.
Neural network 110 does not accept graphical data such as a photograph or other two or three dimensional image.
Neural network 110 does not use attention, which is a known alternative.

### 1.7 Anomaly Detection

FIG. 1B is a block diagram that depicts an example computer 102, in an embodiment. Computer 102 reuses already-trained encoder 171 in a production application that does not include neural network 110. Computer 102 may be a same or different computer than computer 101 in a same or different environment. FIG. 1B is discussed with reference to FIG. 1A.

Computer 102 hosts in memory and operates anomaly detector 195 that, when accepting dense feature vector 145 as input, infers inference 197 that indicates whether or not sequence feature vector 141 is anomalous. Although data structures 141, 145, and 151-154 are shown in both of FIGS. 1A-1B, and although they have the same format and structure in both figures, their content values may or may not differ between both figures. For example, specific instances of messages 151-154 in FIG. 1B may or may not have existed during training of neural network 110 in FIG. 1A. In both of FIGS. 1A-1B, encoder 171 converts sparse feature vector 141 that is a sparse representation of a message sequence into dense feature vector 145 that is a dense encoding.

In various embodiments, anomaly detector 195 is or is not a machine learning (ML) model that is or is not already trained. In various embodiments, anomaly detector 195 is an ML model, and training is or is not supervised, semi-supervised, or unsupervised. In an embodiment, supervised training uses manual labeling.

In an embodiment, unsupervised training instead uses reconstruction loss as error for backpropagation, in which case anomaly detector 195 learns to detect whether an instance of sequence feature vector 141 is familiar or unfamiliar. In various embodiments, backpropagation does or does not include encoder 171. That is, encoder 171 may or may not be immutable during training of anomaly detector 195.

In an embodiment, anomaly detector 195 is a neural network that is not neural network 110. In various embodiments, anomaly detector 195 is not connected to, does not contain, and is not contained in one, some (e.g. at least two or three), or all of: neural network 110 and internal components 131-132, 162, 172, and 180.

In an embodiment, anomaly detector 195 infers inference 197 that indicates whether or not an instance of sequence feature vector 141 is anomalous or non-anomalous. In an embodiment, anomaly detector 195 is a binary classifier, and inference 197 identifies a class that directly indicates anomalous or non-anomalous. In an embodiment, anomaly detector 195 instead is a numeric regression, and inference 197 contains a numeric anomaly score that measures how unfamiliar, abnormal, or suspicious is an instance of sequence feature vector 141.

For example, the anomaly score may be: a) a probability that an instance of sequence feature vector 141 is anomalous and/or b) based on reconstruction loss. A numeric anomaly score may be compared to an anomaly threshold to detect an anomaly. In a production environment, computer 102 may react by treating an anomalous instance of sequence feature vector 141 in special ways such as alerting it for human attention, logging it for later intensive analysis, rejecting it and not further processing it, further processing it with heightened security such as fewer privileges, and/or adding it to a training corpus for later retraining of encoder 171 in neural network 110.

### 2.0 First Example Training Process

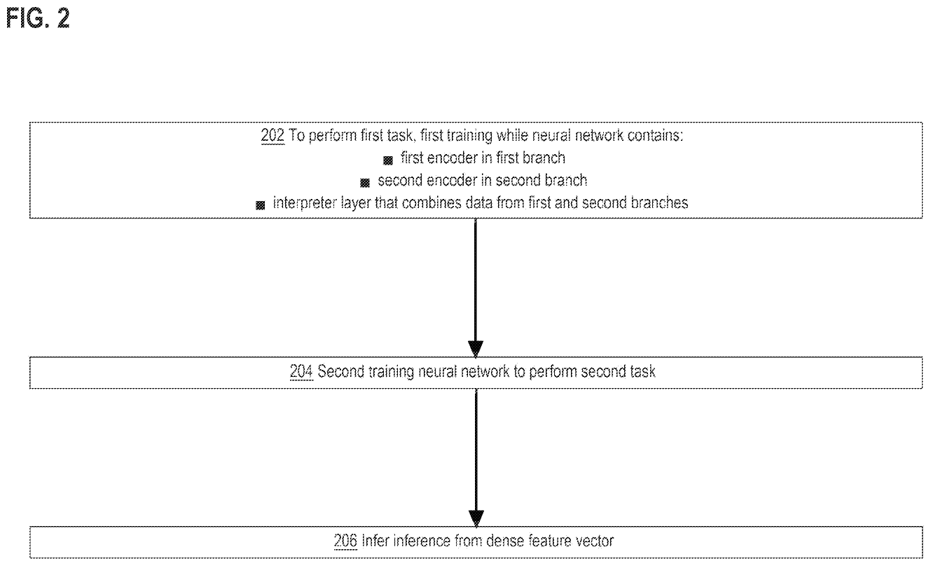

FIG. 2 is a flow diagram that depicts an example process that embodiments of computer 101-102 may perform to avoid overfitting by using multitask learning (MTL) and self-supervised learning (SSL) techniques for training encoder 171 to encode a sequence. FIG. 2 is discussed with reference to FIGS. 1A-1B.

Training steps 202 and 204 correspond to FIG. 1A. Step 206 corresponds to FIG. 1B. Computer 101 and neural network 110 cooperate to perform training steps 202 and 204. Computer 102 and anomaly detector 195 cooperate to perform step 206. Computers 101-102 may be a same or separate computers.

All of steps 202, 204, and 206 use encoder 171 to transcode sparse feature vector 141 into dense feature vector 145. Steps 202 and 204 train neural network 110 and encoder 171. Training steps 202 and 204 do not use anomaly detector 195. Step 206 does not train encoder 171, which may be immutable. Step 206 does not use neural network 110.

Steps 202 and 204 respectively correspond to the first and second trainings. Embodiments having more training (i.e. non-production) tasks may have additional steps for additional trainings. The ordering of training steps (e.g. steps 202 and 204) for neural network 110 depends on the embodiment.

Non-production training tasks are used for MTL and prevent overfitting of encoder 171. Herein, the training environment is anywhere a non-production or production training occurs for neural network 110, and a production environment is anywhere neural network 110 will be deployed into for production use. The production and training environments may be same or different environments, and either environment may be a laboratory environment or an actual production environment.

Which trainings of neural network 110 are or are not multibranch depends on the embodiment. Steps 202 and 204 are example steps in an example MTL training process.

Based on subsequence detection task 191 as the first training task for non-production training to prevent overfitting of encoder 171, step 202 performs the first training while neural network 110 does not contain training layer 132 and simultaneously contains the following internal components:
encoder 171 in branch 161 as a first encoder in a first branch,
encoder 172 in training branch 162 as a second encoder in a second branch,
interpreter layer 180 that combines data from the first and second branches (i.e. from the first and second encoders), and
training layer 131 that is dedicated to learning the first training task.

Based on corruption detection task 192 as the second training task to prevent overfitting of encoder 171, step 204 performs the second training while neural network 110 does not contain internal components 131, 162, 172, and 180 and simultaneously contains the following internal components:
encoder 171 in branch 161, and
training layer 132 that is dedicated to learning the second training task.

In step 206, anomaly detector 195 infers inference 197 that indicates whether or not sequence feature vector 141 is anomalous. In step 206, encoder 171 transcodes sparse feature vector 141 into dense feature vector 145, and then anomaly detector 145 accepts dense feature vector 145 as input for inferencing. Inference 197 is directly based on dense feature vector 145 and indirectly based on sparse feature vector 141.

Although detection tasks 191-192 and anomaly detection are all effectively binary classification tasks, other embodiments may have non-production training tasks and a production task of other functions such as clustering or regression, including a mix of training tasks of different functions. The above example steps and example process demonstrate the following additional aspects of neural network 110 with MTL:
an internal component such as training layer 131 may be present in only one training,
an internal component such as encoder 171 may be present in all trainings of neural network 110 and of anomaly detector 195, and
which internal component accepts output directly from an internal component such as encoder 171 may vary across trainings. For example, the output of encoder 171 is accepted directly by interpreter layer 180 in the first training and instead directly by training layer 132 in the second training.

### 3.0 Second Example Training Process

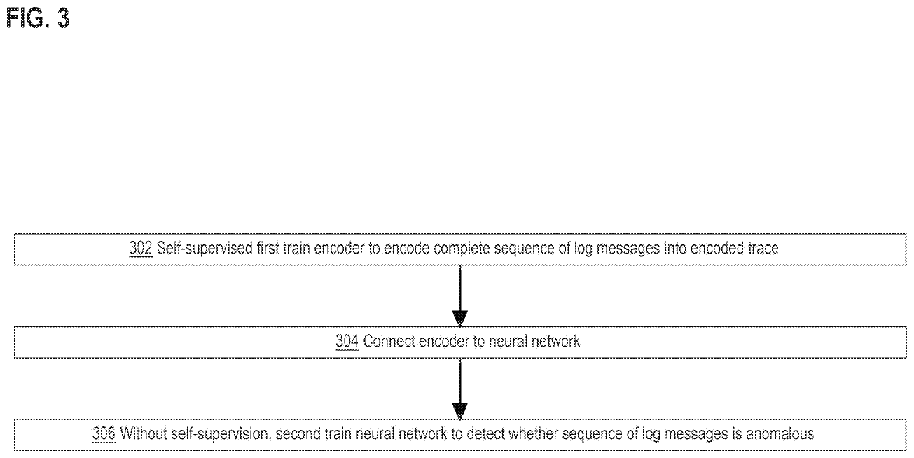

FIG. 3 is a flow diagram that depicts an example training process that embodiments of computers 101-102 may perform using self-supervised learning (SSL) techniques for training encoder 171 to encode a sequence. FIG. 3 is discussed with reference to FIGS. 1A-1B. The steps and/or processes of FIGS. 2-3 may be complementary, interleaved, and/or combined.

Step 302 corresponds to FIG. 1A. Steps 304 and 306 correspond to FIG. 1B. In an embodiment, computer 101 and encoder 171 cooperate to perform step 302. Computer 102 and anomaly detector 195 cooperate to perform steps 304 and 306. Computers 101-102 may be a same or separate computers.

All of steps 302, 304, and 306 involve encoder 171 in various ways. Steps 302 and 306 use encoder 171 to transcode sparse feature vector 141 into dense feature vector 145. Step 302 trains encoder 171 and does not use anomaly detector 195.

In this example, anomaly detector 195 is an untrained neural network that is not neural network 110. Steps 304 and 306 do not use neural network 110. In an embodiment, the process of FIG. 3 does not use neural network 110.

To prevent overfitting of encoder 171, step 302 self-supervised first trains encoder 171 to encode a sequence of log messages into an encoded trace. Here, the encoded trace is contained in dense feature vector 145 that is the dense output of encoder 171 as discussed earlier herein, and a trace is a message sequence. Here, the sequence is the uniform sequence of messages in sequence feature vector 141 that is sparse as discussed earlier herein. Here, this first training may or may not be the first or second training of FIGS. 1A and 2.

Here, self-supervised training of encoder 171 entails backpropagation that, in various embodiments, does or does not occur during self-supervised training of neural network 110 as discussed earlier herein. Various embodiments of encoder 171 may self-supervised train encoder 171 per step 302 or instead unsupervised train encoder 171 such as with reconstruction error as discussed earlier herein.

In various embodiments, step 302: a) trains encoder 171 in deep neural network 110, b) trains encoder 171 in a different DNN, or c) trains encoder 171 without a DNN. For example, encoder 171 may train with a DNN (or without a DNN) in a future proof way that facilitates steps 304 and 306 occurring later with anomaly detector 195 for a new software application that was not conceived when step 302 occurred.

Step 304 connects encoder 171 to anomaly detector 195 or embeds encoder 171 within anomaly detector 195.

Without self-supervision, step 306 second trains anomaly detector 195 to detect whether the sequence of log messages in sequence feature vector 141 is or is not anomalous. Step 306 may be unsupervised or supervised such as based on hand labeling. Unsupervised training of anomaly detector 195 may be based on reconstruction error as discussed earlier herein.

### 4.0 Third Example Training Process

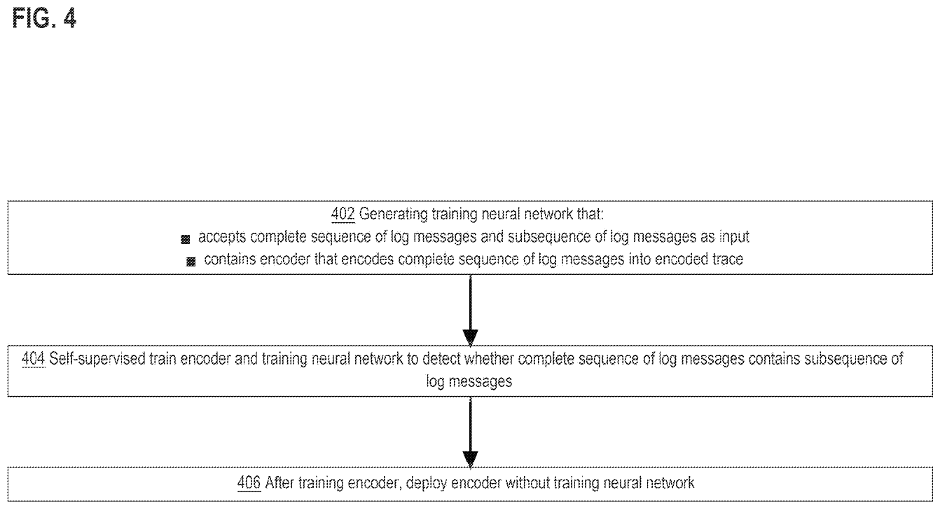

FIG. 4 is a flow diagram that depicts an example process that embodiments of computers 101-102 may perform for future proof training of encoder 171. FIG. 4 is discussed with reference to FIGS. 1A-1B. The steps and/or processes of FIGS. 2-4 may be complementary, interleaved, and/or combined.

Future proofing may entail: a) training encoder 171 in neural network 110 as a training DNN and then b) deploying encoder 171 in a different DNN or without a DNN.

Steps 402 and 404 correspond to FIG. 1A. Step 406 corresponds to FIG. 1B. In an embodiment, computer 101 and neural network 110 cooperate to perform steps 402 and 404. Computer 102 performs step 406. Computers 101-102 may be a same or separate computers.

All of steps 402, 404, and 406 involve encoder 171 in various ways. Step 404 uses encoder 171 to transcode sparse feature vector 141 into dense feature vector 145. Step 404 trains neural network 110 and encoder 171 and does not use anomaly detector 195.

Step 402 generates neural network 110 that: a) accepts a complete sequence of log messages such as the uniform sequence of messages in sequence feature vector 141 as discussed earlier herein, b) simultaneously accepts a subsequence of log messages as discussed earlier herein, and c) contains encoder 171 that learns to encode sequence feature vector 141 that is sparse into dense feature vector 145 that contains a dense encoded trace. Here, a trace is a message sequence.

Step 404 self-supervised trains encoder 171 and neural network 110 to detect whether the complete sequence of log messages contains the subsequence of log messages per subsequence detection task 191 as discussed earlier herein.

Step 406 deploys encoder 171 without neural network 110 that was used as a training neural network. In various embodiments, step 406 deploys encoder 171: a) into a different DNN for production use or training of the different DNN or b) without a DNN. If step 406 trains a different DNN, encoder 171 may or may not be immutable during step 406 as discussed earlier herein. Encoder 171 may be future proof so that step 406 may eventually occur with the different DNN for a new software application that was not conceived when training steps 402 and 404 occurred.

### 5.0 Database Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database comprises data and a database dictionary that is stored on a persistent memory mechanism, such as a set of hard disks. A database is defined by its own separate database dictionary. A database dictionary comprises metadata that defines database objects contained in a database. In effect, a database dictionary defines much of a database. Database objects include tables, table columns, and tablespaces. A tablespace is a set of one or more files that are used to store the data for various types of database objects, such as a table. If data for a database object is stored in a tablespace, a database dictionary maps a database object to one or more tablespaces that hold the data for the database object.

A database dictionary is referred to by a DBMS to determine how to execute database commands submitted to a DBMS. Database commands can access the database objects that are defined by the dictionary.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, such as Oracle Database 11g. SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

A multi-node database management system is made up of interconnected nodes that share access to the same database. Typically, the nodes are interconnected via a network and share access, in varying degrees, to shared storage, such as with shared access to a set of disk drives and data blocks stored thereon. The nodes in a multi-node database system may be in the form of a group of computers, such as work stations and/or personal computers, that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### 5.1 Query Processing

A query is an expression, command, or set of commands that, when executed, causes a server to perform one or more operations on a set of data. A query may specify source data object(s), such as table(s), column(s), view(s), or snapshot(s), from which result set(s) are to be determined. For example, the source data object(s) may appear in a FROM clause of a Structured Query Language (“SQL”) query. SQL is a well-known example language for querying database objects. As used herein, the term “query” is used to refer to any form of representing a query, including a query in the form of a database statement and any data structure used for internal query representation. The term “table” refers to any source object that is referenced or defined by a query and that represents a set of rows, such as a database table, view, or an inline query block, such as an inline view or subquery.

The query may perform operations on data from the source data object(s) on a row by-row basis as the object(s) are loaded or on the entire source data object(s) after the object(s) have been loaded. A result set generated by some operation(s) may be made available to other operation(s), and, in this manner, the result set may be filtered out or narrowed based on some criteria, and/or joined or combined with other result set(s) and/or other source data object(s).

A subquery is a portion or component of a query that is distinct from other portion(s) or component(s) of the query and that may be evaluated separately (i.e., as a separate query) from the other portion(s) or component(s) of the query. The other portion(s) or component(s) of the query may form an outer query, which may or may not include other subqueries. A subquery nested in the outer query may be separately evaluated one or more times while a result is computed for the outer query.

Generally, a query parser receives a query statement and generates an internal query representation of the query statement. Typically, the internal query representation is a set of interlinked data structures that represent various components and structures of a query statement.

The internal query representation may be in the form of a graph of nodes, each interlinked data structure corresponding to a node and to a component of the represented query statement. The internal representation is typically generated in memory for evaluation, manipulation, and transformation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

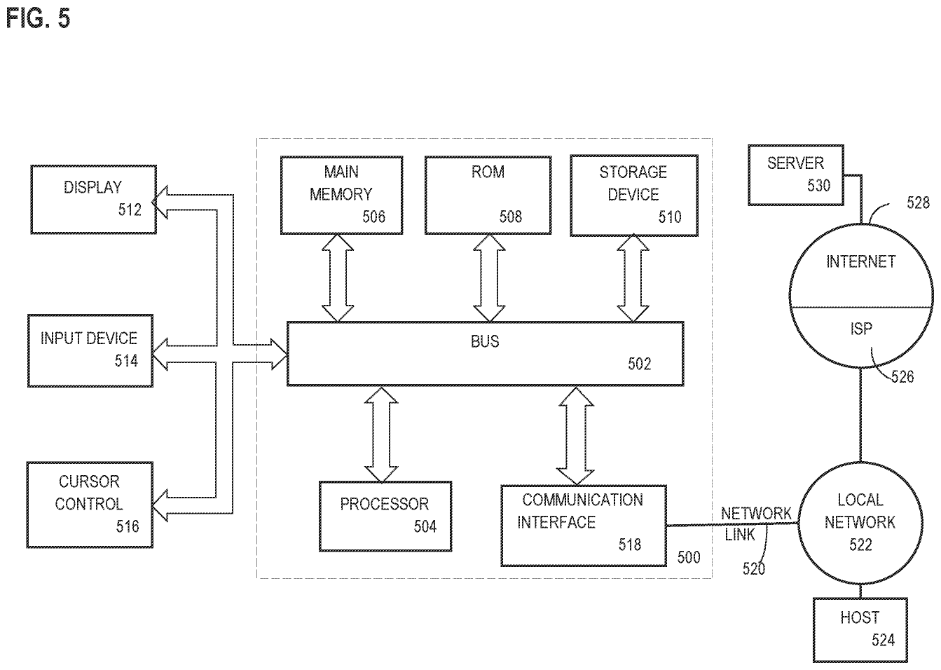

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

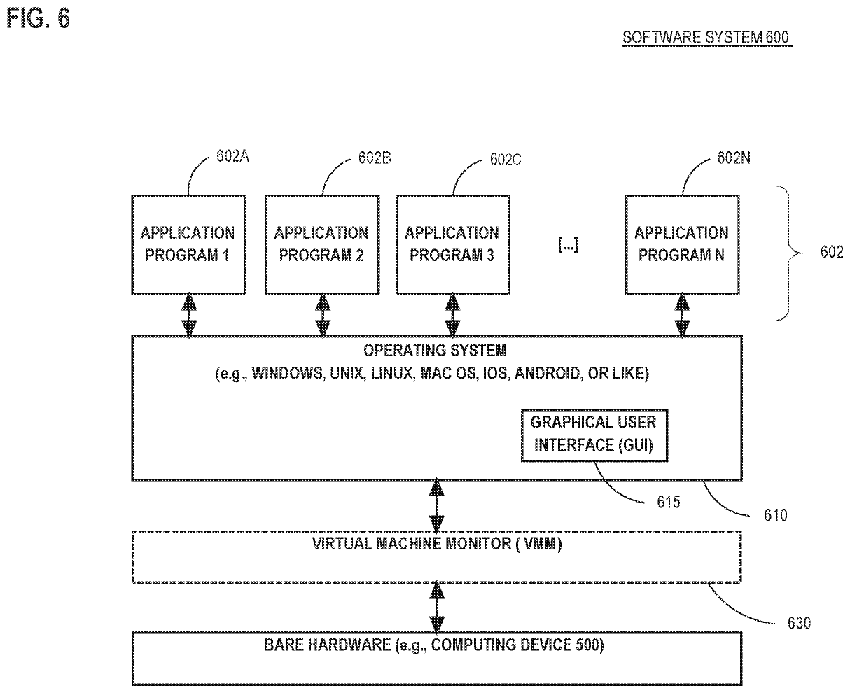

FIG. 6 is a block diagram of a basic software system 600 that may be employed for controlling the operation of computing system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computing system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
first training a neural network to perform a first task, wherein the neural network contains:
a first encoder in a first branch,
a second encoder in a second branch, and
an interpreter layer that combines data from the first branch and the second branch;
second training the neural network to perform a second task;
after the first training and the second training, performing:
encoding, by the first encoder, a sparse feature vector into a dense feature vector, and
inferring an inference from the dense feature vector;
wherein said performing after the first training and the second training does not use at least one selected from the group consisting of: the neural network, the interpreter layer, the second branch, and the second encoder.

2. The method of claim 1 wherein the neural network does not comprise at least one selected from the group consisting of:
the interpreter layer during the second training,
the second branch during the second training,
a convolutional neural network (CNN),
a recurrent neural network (RNN), and
a natural language processing (NLP) transformer.

3. The method of claim 1 wherein:
the neural network contains, during the first training, a first task layer to perform the first task;
the neural network contains, during the second training, a second task layer to perform the second task;
the neural network simultaneously contains only one of the first task layer and the second task layer.

4. The method of claim 1 wherein:
a particular task detects whether a sequence of messages matches a particular condition selected from the group consisting of:
the sequence of messages is corrupted, and
the sequence of messages is anomalous;
the particular task is selected from the group consisting of the second task and the inferring.

5. The method of claim 1 further comprising the first branch accepting feature vectors of a same width during the first training and the second training.

6. The method of claim 1 wherein a self-supervised task is one selected from the group consisting of the first task and the second task.

7. The method of claim 6 wherein:
the method further comprises third training a machine learning model that does not comprise the neural network;
the third training is not self-supervised;
the inferring is performed by the machine learning model.

8. A method comprising:
self-supervised first training an encoder to encode a sequence of log messages into an encoded trace;
connecting, after the first training, the encoder to a neural network;
second training the neural network to detect whether a sequence of log messages is anomalous, wherein the second training is not self-supervised.

9. The method of claim 8 wherein the sequence of log messages is a sequence of database commands.

10. A method comprising:
generating a neural network that accepts a complete sequence of log messages and a subsequence of log messages as input, wherein the neural network contains an encoder that can encode the complete sequence of log messages into an encoded trace;
self-supervised training the neural network to detect whether the complete sequence of log messages contains the subsequence of log messages, wherein the training the neural network comprises training the encoder;
deploying, after the training the encoder, the encoder without the neural network.

11. One or more non-transitory computer-readable media storing instructions that, when executed by one or more processors, cause:
first training a neural network to perform a first task, wherein the neural network contains:
a first encoder in a first branch,
a second encoder in a second branch, and
an interpreter layer that combines data from the first branch and the second branch;
second training the neural network to perform a second task;
after the first training and the second training, performing:
encoding, by the first encoder, a sparse feature vector into a dense feature vector, and
inferring an inference from the dense feature vector;
wherein said performing after the first training and the second training does not use at least one selected from the group consisting of: the neural network, the interpreter layer, the second branch, and the second encoder.

12. The one or more non-transitory computer-readable media of claim 11 wherein the neural network does not comprise at least one selected from the group consisting of:
the interpreter layer during the second training,
the second branch during the second training,
a convolutional neural network (CNN),
a recurrent neural network (RNN), and
a natural language processing (NLP) transformer.

13. The one or more non-transitory computer-readable media of claim 11 wherein:
the neural network contains, during the first training, a first task layer to perform the first task;
the neural network contains, during the second training, a second task layer to perform the second task;
the neural network simultaneously contains only one of the first task layer and the second task layer.

14. The one or more non-transitory computer-readable media of claim 11 wherein:
a particular task detects whether a sequence of messages matches a particular condition selected from the group consisting of:
the sequence of messages is corrupted, and
the sequence of messages is anomalous;
the particular task is selected from the group consisting of the second task and the inferring.

15. The one or more non-transitory computer-readable media of claim 11 wherein the instructions further cause the first branch accepting feature vectors of a same width during the first training and the second training.

16. The one or more non-transitory computer-readable media of claim 11 wherein a self-supervised task is one selected from the group consisting of the first task and the second task.

17. The one or more non-transitory computer-readable media of claim 16 wherein:
the instructions further cause third training a machine learning model that does not comprise the neural network;
the third training is not self-supervised;
the inferring is performed by the machine learning model.

18. One or more non-transitory computer-readable media storing instructions that, when executed by one or more processors, cause:
self-supervised first training an encoder to encode a sequence of log messages into an encoded trace;
connecting, after the first training, the encoder to a neural network;
second training the neural network to detect whether a sequence of log messages is anomalous, wherein the second training is not self-supervised.

19. The one or more non-transitory computer-readable media of claim 18 wherein the sequence of log messages is a sequence of database commands.

20. One or more non-transitory computer-readable media storing instructions that, when executed by one or more processors, cause:
generating a neural network that accepts a complete sequence of log messages and a subsequence of log messages as input, wherein the neural network contains an encoder that can encode the complete sequence of log messages into an encoded trace;
self-supervised training the neural network to detect whether the complete sequence of log messages contains the subsequence of log messages, wherein the training the neural network comprises training the encoder;
deploying, after the training the encoder, the encoder without the neural network.
